(19) United States
(12) Patent Application Publication
(10) Pub. No.: US 2011/0017617 A1
(43) Pub. Date: Jan. 27, 2011

(54) CLEANSING IMPLEMENT

(76) Inventors: Paul Hugh Findlay, Chester (GB); Artur Stanislaw Torz, Wirral (GB); Giovanni Francesco Unali, Wirral (GB)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/679,693

(22) PCT Filed: Sep. 26, 2008
(86) PCT No.: PCT/EP08/62962

§ 371 Date: Oct. 7, 2010

(30) Foreign Application Priority Data
Sep. 28, 2007 (EP) 07117467.6

(51) Int. Cl. B65D 71/00; B08B 1/00; B05D 3/10

(52) U.S. Cl. 206/223; 15/104.93; 427/337

(57) ABSTRACT

A cleansing implement comprising a generally planar compressed, water-swellable matrix and a solid cleansing composition coated on one face of the compressed matrix. A method for producing a cleansing implement comprising providing a generally planar compressed water-swellable matrix and coating a solid cleansing composition on one face of the compressed matrix.

The present invention relates to a cleansing implement.

US 2005/0208111 discloses a dry disposable flexible article comprises water insoluble core layer made of cellulosic material between two water insoluble non-woven layers comprised of synthetic fibres. It has perforations that assist in controlling water absorption into the core required for activating the cleaning solution and for the controlled and repeated release of the cleaning solution on its activation by the absorbed water.

EP 1 459 672 discloses a cleansing implement including a first outer layer; a second outer layer; and an inner layer disposed and retained between the outer layers, wherein at least one of the layers is water permeable, and the inner layer includes means for expanding the implement to at least about 1.5 times its original height.

Despite the prior art there is a need for improved cleansing products for convenience use.

According to the present invention, there is provided a cleansing implement comprising a generally planar compressed, water-swellable matrix and a solid cleansing composition coated on one face of the compressed matrix.

Preferably, the implement is suitable for use on human skin.

Conveniently, the implement expands on contact with water.

Advantageously, the implement comprises less than 10%, preferably less than 5% and especially preferably less than 2% wt. water.

Preferably, the cleansing composition comprises less 10%, preferably less than 5% and especially preferably less than 2% wt. water.

Conveniently, the matrix comprises a polysaccharide.

Advantageously, the matrix comprises a polysaccharide derived from beta-glucose.

Preferably, the matrix comprises cellulose.

Conveniently, the matrix comprises chitosan.

Advantageously, the matrix comprises PVA.

Preferably, the implement is compressed from average depth A to average depth 0.01 to 0.5 A, preferably 0.05 to 0.2 A and most preferably from 0.08 A to 0.12 A.

Conveniently, a cleansing composition is impregnated into the matrix.

Advantageously, the cleansing composition comprises a surfactant selected from anionic, cationic, non-ionic and zwitterionic surfactants.

Preferably, the cleansing composition comprises a skin benefit agent.

Conveniently, the solid cleansing composition is in the form of a sheet.

Advantageously, the solid cleansing composition is coated on substantially all of the one face of the compressed matrix.

Conveniently, the implement is a pad.

Advantageously, the implement comprises a logo printed or embossed thereon.

According to another aspect of the invention, there is provide a package comprising a plurality of cleansing implements of the invention and outer wrapping, the outer wrapping being substantially water impermeable.

According to a further aspect of the invention, there is provided a method for producing a cleansing implement comprising providing a generally planar compressed water-swellable matrix and coating a solid cleansing composition on one face of the compressed matrix.

Preferably, water is applied to the compressed matrix, followed by coating the one face of the matrix with the solid cleansing composition.

Conveniently, water is applied to the solid cleansing composition before being coated on the one face of the compressed matrix.

Alternatively, the step of coating the solid cleansing composition onto the one face of the compressed matrix is performed without the addition of water.

Preferably, the step of coating the solid cleansing composition onto the one face of the matrix is performed after compressing the matrix.

Conveniently, the method further comprises the step of impregnating the matrix with a cleaning composition.

Alternatively, the method further comprises a drying step after the solid cleansing composition is coated onto the one face of the matrix.

The matrix of the cleansing implement is compressed and is water-swellable. Preferably, the matrix is compressed to from average depth A to average depth 0.01 to 0.5 A, preferably 0.05 to 0.2 A and most preferably from 0.08 A to 0.12 A.

Preferably, the compressed implement has a thickness of from 0.5 to 5 mm and more preferably from 0.8 to 3 mm. Preferably this is the average thickness along an axis in the general plane of the implement the axis passing through the implement's centre point on said plane.

Preferably, the fully expanded implement has a thickness of from 5 to 50 mm and more preferably from 8 to 30 mm. Preferably this is the average thickness along an axis in the general plane of the implement the axis passing through the implement's centre point on said plane.

Preferably, the implement is a pad and is a square, rectangle, circle, oval, ellipse or other such regular pattern in plan view.

The implement may also be irregularly shaped and have a varying thickness along said axis. For example, when expanded the implement may, in cross section, be circular, elliptical or oval in shape.

Preferably, the implement is suitable for us on human skin. By this is meant that it comprises materials which do not overly abrade the human skin.

Preferably, the implement comprises less than 10%, preferably less than 5% and especially preferably less than 2% wt. water. This prevents the implement from dimpling at the surface where water has contacted the product somewhere in the implement's body. This also allows the implement to retain an attractive, regular appearance, especially where the cleansing composition provides a glossy surface.

Preferably, the cleansing composition comprises less 10%, preferably less than 5% and especially preferably less than 2% wt. water.

Preferably, the matrix comprises a polysaccharide. More preferably, the polysaccharide is one derived from beta-glucose such as cellulose. Suitable sources of cellulose may also be used to make the matrix. Suitable sources include wood-pulp, cotton, hemp, jute and flax.

Conveniently, the matrix comprises chitosan or PVA.

Preferably, the cleansing composition is coated on and impregnated into the matrix.

Preferably, the cleansing composition comprises a surfactant selected from anionic, cationic, non-ionic and zwitterionic surfactants.

Preferably, the cleansing composition comprises a skin benefit agent. Suitable skin benefit agents include conditioners, moisturizers, exfoliants, sun-protection factors,

Preferably, the implement comprises a logo printed thereon. Printing is effected by any standard means such as ink-jet and laser printing.

A package comprising a plurality of cleansing implements as described in any preceding claim and outer wrapping, the outer wrapping being substantially water impermeable.

In a second aspect the present invention provides a method for making an implement according to the first aspect, the method comprising presenting a suitably dimensioned implement as described in the first aspect of the invention, compressing it and then applying to it a cleansing composition comprising less than 10% wt. water.

The implement may be compressed following any standard process for example rolling or pressing.

The cleansing composition may also be applied prior to compressing.

The cleansing composition in solid form is coated onto one surface of the generally planar compressed matrix. The solid cleansing composition can be in the form of a sheet or may have other shapes.

Preferably, the solid cleansing composition is coated on the matrix such that it substantially covers one face of the compressed matrix. In other embodiments, the solid cleansing composition is coated onto the one face of the matrix such that it covers less than the total surface area of the one face.

In other words, one of the two faces or sides of the compressed matrix is coated with the solid cleansing composition, whilst the other face or side of the compressed matrix is substantially free of the solid cleansing composition.

In addition to being coated on one face of the matrix, a cleansing composition may additionally added to the matrix in a liquid form, such as a solution or suspension.

Preferably the cleaning implement comprises a generally planar water-swellable compressed matrix having a solid cleansing composition coated on one face in addition to a cleansing composition impregnated in the matrix.

Preferably, the cleansing composition comprises all the cleansing components and optionally any benefit agent components all dissolved or suspended in a non-aqueous solvent such as ethanol.

The solid cleansing composition may be coated onto the one face of the matrix as follows. In a preferred embodiment, a previously prepared solid cleansing composition is contacted with sufficient water to enable it to be contacted with and coated on the one face of the matrix. Alternatively, the matrix may itself be contacted with sufficient water to enable it to be coated with the solid cleansing composition. Furthermore, both the matrix and the solid cleansing composition may be contacted with water before being brought together.

In another preferred embodiment, the solid cleansing composition is prepared such that it retains sufficient tackiness, for example by having a sufficiently high level of water, to enable it to be contacted with and coated onto one face of the matrix. In this way, the solid cleansing composition may be prepared and attached to the matrix in a continuous or semi-continuous manner.

Preferably, the matrix does not contain any binder or other material to help it retain its compressed form. In a preferred embodiment, the matrix comprises cellulose and does not contain any such binder.

The cleansing composition can also be applied to the compressed sponge by taking a dry-sheet of cleanser such as those used by campers (Leafz®), misting with water and then applying to the compressed sponge. There is sufficient water in the misting process to slightly expand the sponge without changing its overall dimension and in the process stick to the sheet of cleanser. The cleansing implement may then be used by the consumer.

The cleansing composition according to the invention may also be supplemented with any of the following actives:

Anti-acne, anti-wrinkle, tanning agents, anti-microbial actives, anti-fungal actives, sunscreens, cosmetics, vitamins, anti-cellulite actives, skin-lightening agents, anti-perspirants, anti-virals, exothermic zeolites, exfoliants, fragrances, conditioning agents and mixtures thereof.

The present invention provides a number of important advantages. Firstly, providing the compressed matrix with a solid cleansing composition on one face leaves the other face of the matrix in a condition to be easily held and retained by a user. In other words, if the implement is being used in a shower, the user can hold one face of the implement in their hand which is not coated with a potentially slippery cleansing composition.

Also, the user is able to directly feel the expansion of the matrix when the cleansing implement is contacted with water.

Another advantage is that the solid cleansing composition on face of the matrix is available for immediate use by the user. In other words, the implement may be immediately used for cleansing purposes by the user upon contact with water, which may not be the case if the cleansing composition was not provided on the outer surface of the implement.

The structure also allows for inexpensive and simple manufacture. In particular, the sponge and the solid cleansing composition may be manufactured separately, potentially at different times and at different sites. The compressed matrix and the solid composition may then be brought together and readily adhered. The coating process can be easy to perform by misting at least one of the matrix and the solid coating composition with an aqueous liquid and thereafter bringing them together.

An alternative preferred method of preparing the implement of the invention is to prepare the solid cleansing composition, leaving it with sufficient tackiness to enable it to be directly coated onto one face of the matrix. For example, the solid coating composition may be prepared containing a sufficiently high level of water to give it enough tackiness for it to be contacted and coated onto one face of the matrix.

The cleaning implements may be used in personal care applications, for example as a cleansing implement to be used by a user in the shower. They may also or alternatively be used in other forms of cleansing, such as hard surface applications.

A user of the implement in, for example, a shower may use the cleaning implement to clean the surfaces of the shower area after using it for personal cleansing.

### EXAMPLE 1

A cellulose sponge was compressed to 10% of its original thickness with a press. A standard shower-gel composition was dried in the oven and dissolved in ethanol. The dried shower-gel composition in ethanol was then applied to the surface of the compressed sponge and then oven-dried.

The sponge can be activated by dunking in water.

### EXAMPLE 2

A cellulose sponge was compressed to 10% of its original thickness with a press. A sheet of cleansing composition (solid soap) was misted with a small amount of water. The sheet was then pressed into contact with one face of the sponge.

The sponge can be activated by dunking in water.

1. A cleansing implement comprising a generally planar compressed, water-swellable matrix and a solid cleansing composition coated on one face of the compressed matrix.

2. An implement according to claim 1 suitable for use on human skin.

3. An implement according to claim 1 or 2 which expands on contact with water.

4. An implement according to any preceding claim comprising less than 10%, preferably less than 5% and especially preferably less than 2% wt. water.

5. An implement according to any preceding claim wherein the cleansing composition comprises less 10%, preferably less than 5% and especially preferably less than 2% wt. water.

6. An implement according to any preceding claim wherein the matrix comprises a polysaccharide.

7. An implement according to any preceding claim wherein the matrix comprises a polysaccharide derived from beta-glucose.

8. An implement according to any preceding claim wherein the matrix comprises cellulose.

9. An implement according to any of claims 1 to 5 wherein the matrix comprises chitosan.

10. An implement according to any of claims 1 to 5 wherein the matrix comprises PVA.

11. An implement according to any preceding claim which is compressed from average depth A to average depth 0.01 to 0.5 A, preferably 0.05 to 0.2 A and most preferably from 0.08 A to 0.12 A.

12. An implement according to any preceding claim wherein a cleansing composition is impregnated into the matrix.

13. An implement according to any preceding claim wherein the cleansing composition comprises a surfactant selected from anionic, cationic, non-ionic and zwitterionic surfactants.

14. An implement according to any preceding claim wherein the cleansing composition comprises a skin benefit agent.

15. An implement according to any preceding claim wherein the solid cleansing composition is in the form of a sheet.

16. An implement according to any preceding claim wherein the solid cleansing composition is coated on substantially all of the one face of the compressed matrix.

17. An implement according to any preceding claim which is a pad.

18. An implement according to any preceding claim comprising a logo printed or embossed thereon.

19. A package comprising a plurality of cleansing implements as described in any preceding claim and outer wrapping, the outer wrapping being substantially water impermeable.

20. A method for producing a cleansing implement comprising providing a generally planar compressed water-swellable matrix and coating a solid cleansing composition on one face of the compressed matrix.

21. A method according to claim 20 wherein water is applied to the compressed matrix, followed by coating the one face of the matrix with the solid cleansing composition.

22. A method according to claim 20 or 21 wherein water is applied to the solid cleansing composition before being coated on the one face of the compressed matrix.

23. A method according to claim 20 wherein the step of coating the solid cleansing composition onto the one face of the compressed matrix is performed without the addition of water.

24. A method according to any of claims 20 to 23 wherein the step of coating the solid cleansing composition onto the one face of the matrix is performed after compressing the matrix.

25. A method according to any of claims 20 to 24 further comprising the step of impregnating the matrix with a cleaning composition.

26. A method according to any of claims 20 to 25 further comprising a drying step after the solid cleansing composition is coated onto the one face of the matrix.
